(19) United States
(12) Patent Application Publication
(10) Pub. No.: US 2024/0223001 A1
(43) Pub. Date: Jul. 4, 2024

(54) POWER TRANSFER METHOD AND ELECTRONIC APPARATUS FOR EXECUTING POWER TRANSFER METHOD

(71) Applicant: SAMSUNG ELECTRONICS CO., LTD., Suwon-si (KR)

(72) Inventor: Jaedeok CHA, Suwon-si (KR)

(21) Appl. No.: 18/605,080

(22) Filed: Mar. 14, 2024

Related U.S. Application Data
(63) Continuation of application No. PCT/KR2022/011342, filed on Aug. 1, 2022.

(30) Foreign Application Priority Data
Sep. 14, 2021 (KR) 10-2021-0122530

(51) Int. Cl. H02J 7/06; G06F 1/26; H02J 7/00; H02M 3/07

(52) U.S. Cl. CPC H02J 7/06; G06F 1/266; H02J 7/0068; H02M 3/07; H02J 2207/20

(57) ABSTRACT

Disclosed are a power transfer method and an electronic device for executing the power transfer method. The electronic device includes a battery and a charging circuit which, when external power is input, converts an input voltage of the external power into a charge voltage for charging the battery. The electronic device also includes a first conversion circuit which converts one of the charge voltage and a discharge voltage of the battery into a supply voltage according to a conversion ratio and a second conversion circuit which converts the supply voltage and supplies the same to a load. The electronic device also includes a processor which controls the charge circuit and the first conversion circuit, enables the charge voltage to be input to the first conversion circuit when external power is input, and enables the discharge voltage to be input to the first conversion circuit when external power is not input.

### CROSS-REFERENCE TO RELATED APPLICATIONS

This application is a continuation application, claiming priority under § 365(c), of International Application No. PCT/KR2022/011342, filed on Aug. 1, 2022, which is based on and claims the benefit of Korean patent application number 10-2021-0122530 filed on Sep. 14, 2021, in the Korean Intellectual Property Office, the disclosures of which are incorporated by reference herein in their entireties.

### BACKGROUND

### Technical Field

The following disclosure relates to power transfer methods and an electronic device for executing the power transfer methods.

### Description of Related Art

By reducing the power consumption of an electronic device, it may be possible to reduce standby power consumption in an alternating current (AC) mode using external power and improve the battery life in a direct current (DC) mode using an internal power source (e.g., a battery).

The power flow of the electronic device may be supplied to a load through a power divider, such as a point of load (POL) DC-to-DC converter from a power source like an AC adapter.

Improvements in the switching scheme of an AC adapter, adoption of a power-saving mode in the POL DC-to-DC converter, and implementation of power management technology of the final-stage load are being pursued to facilitate low-power operation of the electronic device.

### SUMMARY

According to various embodiments, an electronic device for executing a power transfer method includes a battery, a charging circuit configured to, when an external power source is input, convert an input voltage of the external power source into a charging voltage for charging the battery, a first conversion circuit configured to convert one of a discharging voltage and the charging voltage of the battery into a supply voltage according to a conversion ratio, a second conversion circuit configured to convert the supply voltage and supply the converted supply voltage to a load, and a processor configured to control the charging circuit and the first conversion circuit, wherein the processor is configured to enable the charging voltage to be input to the first conversion circuit when the external power source is input and enable the discharging voltage to be input to the first conversion circuit when the external power source is not input.

According to various embodiments, an electronic device for executing a power transfer method includes a battery, a charging circuit configured to provide a charging voltage using an input external power source, a first conversion circuit configured to convert a voltage transmitted from the battery or the charging circuit into a supply voltage according to a conversion ratio, a second conversion circuit configured to convert the supply voltage into a voltage required for a connected load, and a processor configured to control operation of the charging circuit and the first conversion circuit, wherein the processor is configured to charge the battery using the charging voltage and enable the charging voltage to be input to the first conversion circuit when the externa power source is input and enable a discharging voltage output from the battery to be input to the first conversion circuit when the external power source is not input, and the conversion ratio may be determined based on a magnitude of the charging voltage or the discharging voltage and a magnitude of a voltage required to operate the second conversion circuit.

According to various embodiments, a power transfer method includes, when an external power source is input, converting an input voltage of the external power source into a charging voltage for charging a battery, converting one of a discharging voltage or the charging voltage of the battery input to a first conversion circuit into a supply voltage according to a conversion ratio, and converting the supply voltage in a second conversion circuit and supplying the converted supply voltage to a load, wherein the converting of one of the discharging voltage or the charging voltage of the battery into the supply voltage may include enabling the charging voltage to be input to the first conversion circuit when the external power source is input and enabling the discharging voltage to be input to the first conversion circuit when the external power source is not input.

According to various embodiments disclosed herein, by controlling the magnitude of a voltage supplied to a second conversion circuit using a first conversion circuit, it may be possible to increase the input-output voltage conversion ratio of the second conversion circuit and improve power efficiency.

According to various embodiments disclosed herein, by controlling the conversion ratio of the first conversion circuit according to the magnitude of the discharging voltage of a battery input to the first conversion circuit or the magnitude of a charging voltage converted from an external voltage, it may be possible to supply a voltage that is greater than or equal to the minimum magnitude of the voltage required for the second conversion circuit to ensure the operation of an electronic device and improve power efficiency as the value of the input-output voltage conversion ratio of the second conversion circuit increases.

### BRIEF DESCRIPTION OF THE DRAWINGS

The above and other aspects, features, and advantages of certain embodiments of the present disclosure will be more apparent from the following detailed description, taken in conjunction with the accompanying drawings.

FIG. 1 is a block diagram of an electronic device in a network environment according to various embodiments.

FIG. 2 is a block diagram of a power conversion module, a power management module, and a battery according to various embodiments.

FIG. 3 is a diagram illustrating an operation of an electronic device according to various embodiments.

FIG. 4 is a schematic circuit diagram of an electronic device according to various embodiments.

FIG. 5 is a circuit diagram of an electronic device operating on a motherboard, according to various embodiments.

FIG. 6 is a diagram illustrating an operation of a first conversion circuit according to various embodiments.

FIGS. 7A, 7B, and 7C are circuit diagrams of a first conversion circuit having a conversion ratio of 2:1, according to various embodiments.

FIGS. 8A, 8B, and 8C are circuit diagrams of a first conversion circuit having a conversion ratio of 3:1 and a first conversion circuit having a conversion ratio of 4:1, according to various embodiments.

FIG. 9 is a circuit diagram of a second conversion circuit according to various embodiments.

FIGS. 10A and 10B are diagrams illustrating the conversion ratio of a first conversion circuit and a supply voltage according to the magnitude of a charging voltage and a discharging voltage, according to various embodiments.

FIGS. 11A and 11B are diagrams illustrating power efficiency as a supply voltage decreases, according to various embodiments.

FIG. 12 is a diagram illustrating an inductor current of a buck converter, according to various embodiments.

FIG. 13 is a diagram illustrating an efficiency curve according to the voltage conversion ratio of a buck converter according to various embodiments.

FIGS. 14A to 14H and FIG. 15 are diagrams illustrating power efficiency as a supply voltage decreases, according to various embodiments.

FIG. 16 is a diagram illustrating a first conversion circuit operating on a motherboard, according to various embodiments.

FIG. 17 is a flowchart of an operation of a power transfer method according to various embodiments.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

According to various embodiments disclosed herein, it may be possible to provide a power transfer method and an electronic device for executing the power transfer method that may determine a conversion ratio according to the magnitude of a voltage input to a first conversion circuit and control the magnitude of a voltage input to a second conversion circuit that supplies power to a load.

According to various embodiments disclosed herein, it may be possible to provide a power transfer method and an electronic device for executing the power transfer method that may determine the conversion ratio of a first conversion circuit considering the magnitude of a minimum voltage required for a second conversion circuit.

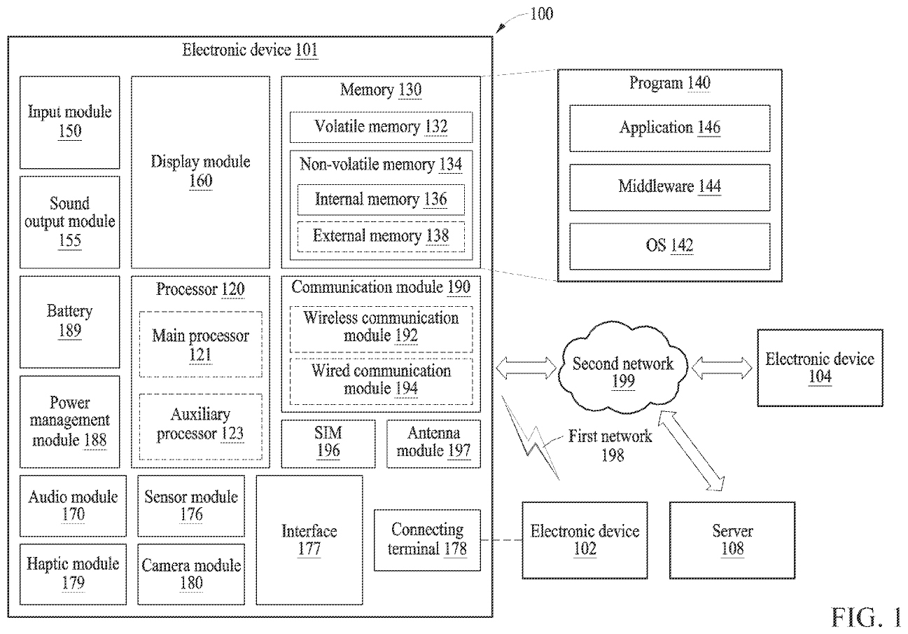

FIG. 1 is a block diagram of an electronic device 101 in a network environment 100 according to various embodiments.

FIG. 1 is a block diagram of the electronic device 101 in the network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a portion of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence (AI) model may be generated through machine learning. Such learning may be performed by, for example, the electronic device 101, in which an AI model is executed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from the outside (e.g., a user) of the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and a control circuit to control a corresponding one of the display, the hologram device, and the projector. According to an embodiment, the display module 160 may include a touch sensor adapted to sense a touch, or a pressure sensor adapted to measure the intensity of force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus, which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to various embodiments, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mm Wave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101.

According to an embodiment, all or some of operations to be executed at the electronic device 101 may be executed at one or more external electronic devices (e.g., the external devices 102 and 104 or the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra low-latency services using, e.g., distributed computing or MEC. In another embodiment, the external electronic device 104 may include an Internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., a smart home, a smart city, a smart car, or healthcare) based on 5G communication technology or IoT-related technology.

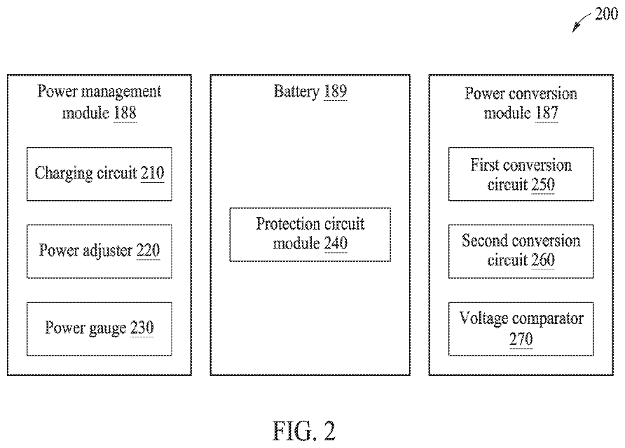

FIG. 2 is a block diagram 200 of a power conversion module 187, a power management module 188, and a battery 189, according to various embodiments. In exemplary embodiments, the power management module 188 may include a charging circuit 210, a power adjuster 220, or a power gauge 230. The charging circuit 210 may charge the battery 189 using power supplied from an external power source outside the electronic device 101. According to an embodiment, the charging circuit 210 may select a charging scheme (e.g., normal charging or fast charging) based at least in part on the type of the external power source (e.g., a power outlet, a USB, or wireless charging), the magnitude of power (e.g., about 20 Watts (W) or more), which may be supplied from the external power source, or an attribute of the battery 189 and may charge the battery 189 using the selected charging scheme. The external power source may be connected to the electronic device 101, for example, by wire via the connecting terminal 178 or wirelessly via the antenna module 197.

The power adjuster 220 may generate a plurality power outputs having different voltage levels or different current levels by adjusting a voltage level or a current level of the power supplied from the external power source or the battery 189. The power adjuster 220 may adjust the voltage level or the current level of the power supplied from the external power source or the battery 189 into a different voltage level or current level appropriate for each of some of the components included in the electronic device 101. According to an embodiment, the power adjuster 220 may be implemented in the form of a low drop out (LDO) regulator or a switching regulator. The power gauge 230 may measure state information about the battery 189 (e.g., the capacity, the number of charging or discharging times, voltage, or the temperature of the battery 189).

The power management module 188 may determine, using, for example, the charging circuit 210, the power adjuster 220, or the power gauge 230, charging state information (e.g., lifetime, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. When it is determined that the state of the battery 189 is abnormal, the power management module 188 may adjust the charging of the battery 189 (e.g., reduce the charging current or voltage or stop the charging). According to an embodiment, at least some of the functions of the power management module 188 may be performed by an external control device (e.g., the processor 120)

According to an embodiment, the battery 189 may include a protection circuit module (PCM) 240. The PCM 240 may perform one or more of various functions (e.g., a pre-cutoff function) to prevent performance deterioration of, or damage to, the battery 189. The PCM 240, additionally or alternatively, may be configured as at least part of a battery management system (BMS) capable of performing various functions including cell balancing, measurement of battery capacity, count of the number of charging or discharging times, measurement of temperature, or measurement of voltage.

According to an embodiment, at least part of the charging state information or use state information regarding the battery 189 may be measured using a corresponding sensor (e.g., a temperature sensor) of a sensor module 176, the power gauge 230, or the power management module 188. According to an embodiment, the corresponding sensor (e.g., a temperature sensor) of the sensor module 176 may be included as part of the PCM 240 or may be disposed near the battery 189 as a separate device.

The power conversion module 187 according to various embodiments may include a first conversion circuit 250, a second conversion circuit 260, and a voltage comparator 270.

The first conversion circuit 250 according to various embodiments may receive a charging voltage from the charging circuit 210 or the discharging voltage of the battery from the battery 189. The first conversion circuit 250 may convert the input charging voltage or discharging voltage and supply a supply voltage to the second conversion circuit 260.

For example, when an external power source is supplied, a processor (e.g., the processor 120 of FIG. 1) may enable the charging circuit 210 and/or the power adjuster 220 of the power management module 188 to operate.

For example, the charging circuit 210 may include a semiconductor element (not shown) for controlling the direction of the current input to and output from the battery 189. The semiconductor element may enable a current to flow from the charging circuit 210 to the battery 189 to charge the battery when the external power source is supplied and may enable a discharging current to flow from the battery 189 when the external power source is not supplied.

The second conversion circuit 260 according to various embodiments may convert the input supply voltage and supply the converted supply voltage to a load. The second conversion circuit 260 may supply power to a final power-consuming load in the electronic device. For example, the second conversion circuit 260 may be located right in front of the load and may be referred to as a point of load (POL) direct current (DC)-to-DC converter.

According to various embodiments, in order to convert a normally input supply voltage and supply the converted supply voltage to the load, the second conversion circuit 260 may receive, from the first conversion circuit 250, a voltage that is greater than or equal to a minimum voltage (e.g., 3.3 volts (V)) required to operate.

According to various embodiments, the power efficiency of the second conversion circuit 260 may vary depending on the input-output voltage conversion ratio of the second conversion circuit 260. The input-output voltage conversion ratio may be a value obtained by dividing the magnitude of the voltage output from the second conversion circuit 260 (or the magnitude of the voltage supplied to the load) by the magnitude of the voltage input to the second conversion circuit 260.

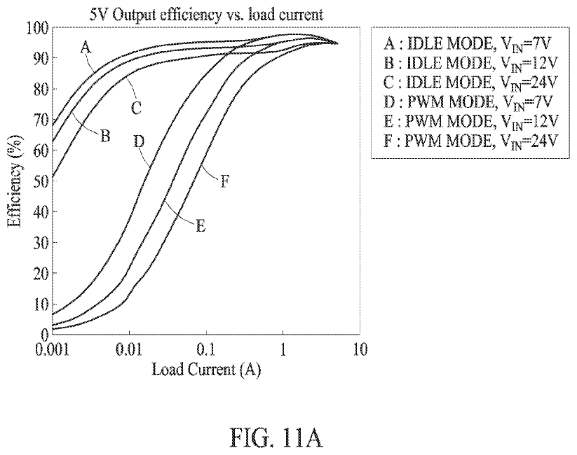

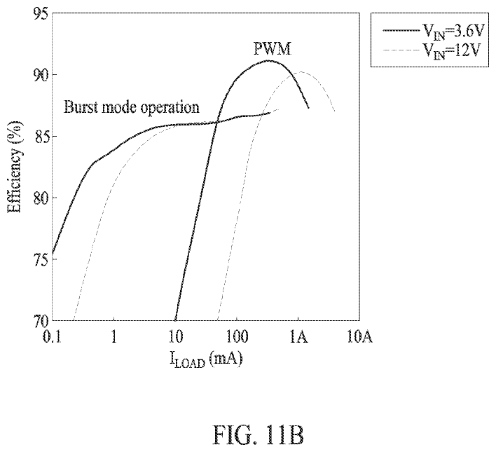

For example, when the input-output voltage conversion ratio of the second conversion circuit 260 is high, the power efficiency of the second conversion circuit 260 may be high. The power efficiency of the second conversion circuit 260 according to the input-output voltage conversion ratio is described in detail with reference to FIGS. 11 to 15.

The voltage comparator 270 according to various embodiments may compare the magnitude of the supply voltage or the discharging voltage input to the first conversion circuit 250 to a set voltage magnitude.

The voltage comparator 270 according to various embodiments may supply a control signal to the first conversion circuit 250 by comparing the supply voltage or discharging voltage input to the first conversion circuit 250 to the set voltage magnitude.

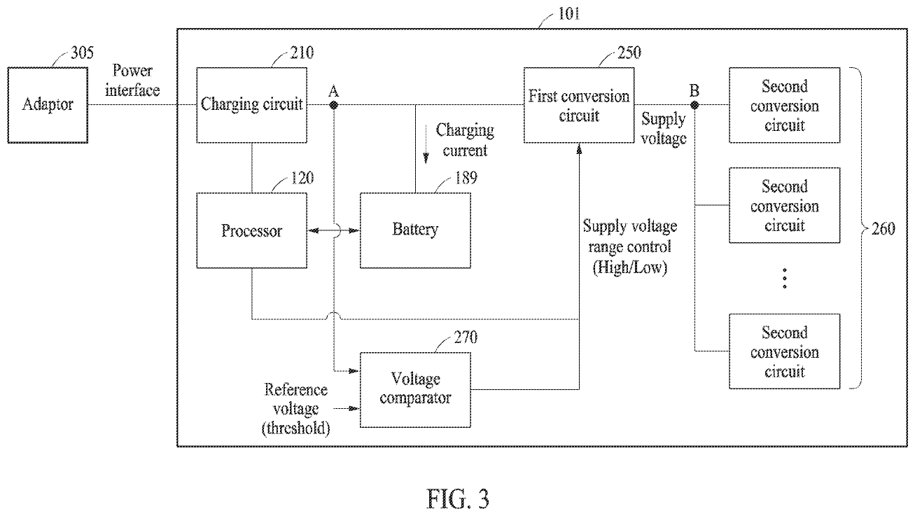

FIG. 3 is a diagram illustrating an operation of the electronic device 101 according to various embodiments.

Referring to FIG. 3, the electronic device 101 according to various embodiments may include the charging circuit 210, the processor 120, the battery 189, the first conversion circuit 250, the second conversion circuit 260, and the voltage comparator 270.

An adapter 305 according to various embodiments may convert input alternating current (AC) power into DC power to supply the DC power to the electronic device 101. The magnitude of the voltage and power of the DC power supplied by the adapter 305 to the electronic device 101 may vary. For example, the magnitude of the voltage of the DC power may vary, such as 5/9/15/20 V, and the magnitude of the power may vary, such as 15/27/45/100 W. For example, the adapter 305 may supply the electronic device 101 with a DC power of 20 volts of direct current (Vdc) and 65 W.

The charging circuit 210 according to various embodiments may convert the input voltage of an external power source into a charging voltage for charging a battery. The charging circuit 210 may receive the external power source from the adapter 305.

The charging circuit 210 according to various embodiments may operate when the external power source is input. For example, the processor 120 may identify whether the adapter 305 is inserted into the electronic device 101. When the adapter 305 is inserted into the electronic device 101, the processor 120 may supply, to the charging circuit 210, a control signal for operating the charging circuit 210.

According to various embodiments, the charging voltage output from the charging circuit 210 to A may be supplied to the battery 189 to charge the battery 189. When the battery 189 is being charged, a charging current may flow from A to the battery 189.

According to various embodiments, the charging voltage output from the charging circuit 210 to A may be supplied to the first conversion circuit 250. The charging voltage input to the first conversion circuit 250 may be supplied only when the adapter 305 is inserted into the electronic device 101 and the processor 120 controls the charging circuit 210 to operate.

According to various embodiments, the charging voltage at A output from the charging circuit 210 may depend on the voltage of the battery 189. In other words, the magnitude of the charging voltage at A may be equal to the magnitude of the voltage of the battery 189.

For example, the battery 189 may have four battery cells connected in series (referred to herein as a 4S battery), and the voltage of each of the battery cells may range from 3 V to 4.35 V, depending on the charging state. A 4S battery with four battery cells connected in series may have a battery charging voltage ranging from 12V to 17.4V, depending on the charging state. The magnitude of the charging voltage output from the charging circuit 210 to A may fall within a range of 12 V or more and 17.4 V or less, corresponding to the charging voltage of the 4S battery. The voltage of the battery 189, the voltage of a battery cell, and the connection structure of the battery cells are not limited to the example described above and may also apply to 3S and 2S batteries.

When receiving the external power source, the battery 189 according to various embodiments may be charged according to the charging voltage converted in the charging circuit 210. When not receiving the external power source, the battery 189 may discharge the charged voltage. Discharging the voltage charged in the battery 189 may be understood as supplying the power charged in the battery 189. When not receiving the external power source, the battery 189 may supply, to the first conversion circuit 250, a discharging voltage according to the magnitude of the voltage charged in the battery 189.

For example, when the battery 189 supplies the discharging voltage to the first conversion circuit 250, the discharging voltage may be applied to A.

For example, the magnitude of the discharge voltage may vary depending on the magnitude of the voltage of the battery 189. As described above, in the case of the 4S battery with four battery cells connected in series, the magnitude of a discharging voltage may be greater than or equal to 12 V and less than or equal to 17.4 V.

The first conversion circuit 250 according to various embodiments may convert one of the input charging voltage or discharge voltage to a supply voltage according to a conversion ratio. For example, the conversion ratio of the first conversion circuit 250 may be N:1. Hereinafter, N in the conversion ratio N: 1 is described as being an integer greater than or equal to 2 for ease of description but is not limited thereto. The conversion ratio of the first conversion circuit 250 may be variously (e.g., 2:1, 3:1, 4:1, 5:1, 2.5:1, or 3.5:1) determined.

For example, the processor 120 of the electronic device 101 may allow the charging voltage or discharging voltage to be input to the first conversion circuit 250, depending on whether a power source is supplied from the outside. As described above, when the adapter 305 is inserted into the electronic device 101, the processor 120 may operate (ON) the charging circuit 210 and supply the charging voltage to the first conversion circuit 250. When the adapter 305 is not inserted into the electronic device 101, the processor 120 may stop (OFF) the operation of the charging circuit 210 and supply the discharging voltage of the battery 189 to the first conversion circuit 250.

According to various embodiments, the range of the charging voltage or discharging voltage input to the first conversion circuit 250 may be wider than the range of the supply voltage converted in and output from the first conversion circuit 250. For example, the voltage input to the first conversion circuit 250 may range from 12 V to 17.4 V and the voltage output from the first conversion circuit 250 may range from 4 V to 5.8 V or from 3 V to 4.35 V, depending on the conversion ratio of the first conversion circuit 250.

According to various embodiments, the conversion ratio of the first conversion circuit 250 may be determined based on the magnitude of the input charging voltage or discharging voltage.

For example, the processor 120 may identify the magnitude of the charging voltage or discharging voltage supplied to the first conversion circuit 250. The processor 120 may determine the conversion ratio of the first conversion circuit 250 by comparing the magnitude of the charging voltage or discharging voltage to a set voltage magnitude. The processor 120 may supply a control signal to the first conversion circuit 250 such that the first conversion circuit 250 operates according to the determined conversion ratio.

For example, the voltage comparator 270 may identify the magnitude of the charging voltage or discharging voltage supplied to the first conversion circuit 250. The voltage comparator 270 may supply the control signal to the first conversion circuit 250 according to the result of comparing the magnitude of the charging voltage or discharging voltage to the set voltage magnitude (e.g., a reference voltage (threshold) of FIG. 3). The conversion ratio of the first conversion circuit 250 may be determined according to the control signal.

According to various embodiments, the conversion ratio of the first conversion circuit 250 may be determined based on the magnitude of the charging voltage or discharging voltage and the magnitude of the voltage required to operate the second conversion circuit 260. For example, the second conversion circuit 260 may include an integrated circuit (IC) to convert a supply voltage and supply the converted supply voltage to a load. Similar to an IC bias voltage required to operate the IC, the second conversion circuit 260 may need to receive a voltage greater than or equal to the magnitude of the voltage (e.g., 3.3 V or more) required to operate the second conversion circuit 260.

The conversion ratio may be determined such that the minimum magnitude of the supply voltage output from the first conversion circuit 250 according to the conversion ratio is greater than the magnitude of the voltage required to operate the second conversion circuit. For example, when the magnitude of the charging voltage or discharging voltage is greater than or equal to 12 V and less than or equal to 14 V, the conversion ratio of the first conversion circuit 250 may be 3:1, and when the magnitude of the charging voltage or discharging voltage is greater than 14 V and greater than or equal to 17.4 V, the conversion ratio of the first conversion circuit 250 may be 4:1.

In other words, because the magnitude of the voltage at B in FIG. 3 may be determined by the magnitude of the voltage at A and the conversion ratio, the conversion ratio may be determined according to the magnitude of the voltage at A such that the magnitude of the voltage at B is greater than the magnitude of the minimum voltage required to operate the second conversion circuit 260.

The second conversion circuit 260 may convert the supply voltage and supply the converted supply voltage to the load. The second conversion circuit 260 may receive the supply voltage output from the first conversion circuit 250. When the second conversion circuit 260 converts the input supply voltage and supplies the converted supply voltage to the load, the input-output voltage conversion ratio of the second conversion circuit 260 may increase compared to when the second conversion circuit converts the output voltage output from the charging circuit 210 and supply the converted output voltage to the load.

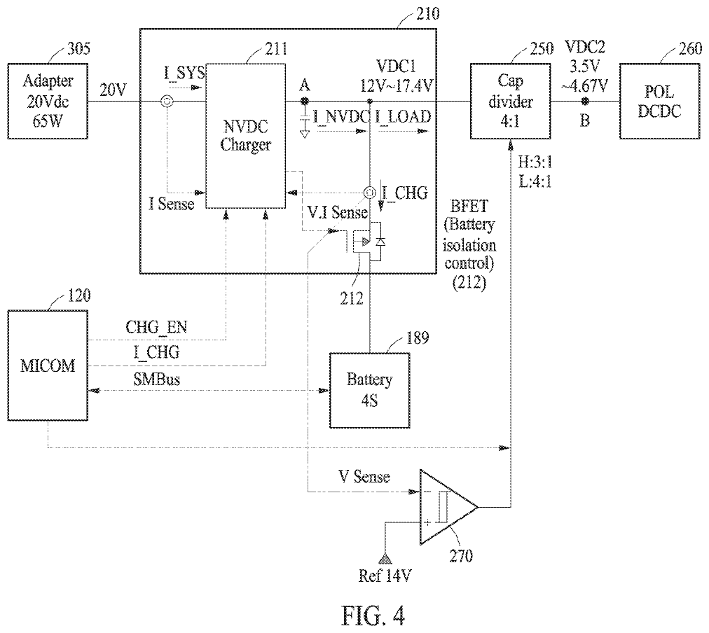

FIG. 4 is a schematic circuit diagram of an electronic device according to various embodiments. FIG. 4 illustrates a circuit diagram of the electronic device 101 including the battery 189 with four battery cells connected in series among various embodiments.

Referring to FIG. 4, the electronic device 101 according to various embodiments may include the charging circuit 210, the processor 120, the battery 189, the first conversion circuit 250, the second conversion circuit 260, and the voltage comparator 270.

FIG. 4 illustrates a case in which the adapter 305 supplies an external power source of 20 Vdc and 65 W to the charging circuit 210 of an electronic device (e.g., the electronic device 101 of FIG. 1), according to various embodiments.

The charging circuit 210 according to various embodiments may include a narrow voltage direct charging (NVDC) charger 211 and a semiconductor element 212.

For example, the NVDC charger 211 may convert the input voltage of an input external power source to a charging voltage to charge the battery 189. For example, the range of the charging voltage may be less than the range of the input voltage of the external power source (e.g., 12 V or more and 17.4 V or less).

For example, the operation of the NVDC charger 211 may be controlled by the processor 120. The processor 120 may identify whether the adapter 305 is inserted into the electronic device 101. When the adapter 305 is inserted, the NVDC charger 211 may supply a high ADT SEL signal to the processor 120. The processor 120 may supply I_CHG, V_CHG, and high CHE_EN signals to the NVDC charger 211. The NVDC charger 211 may operate (ON) according to the high CHE_EN signal.

When the adapter 305 is removed, the NVDC charger 211 may supply a low ADT_SEL signal to the processor 120. The processor 120 may supply a low CHE_EN signal to the NVDC charger 211. The NVDC charger 211 may stop operating (OFF) according to the low

CHE_EN signal.

The semiconductor element 212 according to various embodiments may control the direction of the current input to and output from the battery 189. For example, the semiconductor element 212 may allow a charging current to flow from A to the battery 189 when a charging voltage is supplied to A from the NVDC charger 211. For example, when the adapter 305 is removed and the NVDC charger 211 does not operate, the semiconductor element 212 may allow a current caused by the discharging of the battery 189 from the battery 189 to A.

The processor 120 according to various embodiments may identify information about the battery 189. For example, the processor 120 may identify at least one piece of information about the battery 189 among voltage, current, temperature, relative state of capacity (RSOC), charging-discharging cycle count, status, manufacturer access, and alarm. For example, when the battery 189 is inserted and connected, the processor 120 may identify at least one piece of information about the battery 189 among device name, chemistry, design capacity (DC), and full charge capacity (FCC). RSOC may represent the remaining capacity divided by FCC, while absolute state of charge (ASOC) may represent the remaining capacity divided by design capacity.

The processor 120 according to various embodiments may be configured to identify the information about the battery 189. For example, the processor 120 may identify the information about the battery 189 by being connected to the battery 189 via a system management bus (SMBus).

The processor 120 according to various embodiments may control the operation of the charging circuit 210. The processor 120 may control the charging voltage (V_CHG) and charging current (I_CHG) supplied to the battery 189 from the charging circuit 210.

The processor 120 according to various embodiments may set a charging voltage and a charging current based on the voltage range of the battery cells of the battery 189 and a serial-parallel structure where the battery cells are connected. The processor 120 may supply a control signal, such as I_CHG and V_CHG signals, to the NVDC charger 211, based on the set charging voltage and charging current. The processor 120 may use the control signal such that a constant voltage and a constant current may be controlled in the process of charging the battery 189.

According to various embodiments, the magnitude of the voltage at A in FIG. 3 may be determined based on the battery 189. The voltage applied to A may be the charging voltage output from the NVDC charger 211 or the discharging voltage of the battery 189. The charging voltage applied to A may be controlled by the processor 120 and may be determined based on a characteristic of the battery 189 such as the serial-parallel structure of the battery 189 and the voltage of the battery cells. The discharging voltage applied to A may be determined based on a characteristic of the battery 189 such as the serial-parallel structure of the battery 189, the voltage of the battery cells, and the charging state of the battery 189.

According to various embodiments, the first conversion circuit 250 may convert the input charging voltage or discharging voltage to a supply voltage according to a conversion ratio. FIG. 4 illustrates the first conversion circuit 250 that converts a charging voltage or discharging voltage (VDC1) between 12 V and 17.4 V to a supply voltage (VDC2) between 3.5 V and 4.67 V according to the conversion ratio.

According to various embodiments, the conversion ratio of the first conversion circuit 250 may be determined based on the magnitude of a charging voltage or discharging voltage. For example, the conversion ratio when the magnitude of the discharging voltage or charging voltage is greater than or equal to a set voltage magnitude may be less than the conversion ratio when the magnitude of the discharging voltage or charging voltage is less than the set voltage magnitude.

In other words, the conversion ratio of the first conversion circuit 250 when the magnitude of the voltage at A is greater than the set voltage magnitude may be less than the conversion ratio of the first conversion circuit 250 when the magnitude of the voltage at A is less than the set voltage magnitude. The conversion ratio of the first conversion circuit 250 may be a value obtained by dividing the magnitude of the voltage at B (VDC2) by the magnitude of the voltage at A (VDC1).

For example, when the magnitude of the charging voltage or discharging voltage at A is greater than 14 V and less than or equal to 17.4 V, the conversion ratio of the first conversion circuit 250 may be determined to be 4:1, and a supply voltage may be greater than 3.5 V and less than or equal to 4.35 V.

For example, when the magnitude of the charging voltage or discharging voltage at A is greater than or equal to 12 V and less than 14 V, the conversion ratio of the first conversion circuit 250 may be determined to be 3:1, and the supply voltage may be greater than or equal to 4 V and less than or equal to 4.67 V.

When the voltage at A is 14 V, the supply voltage may be 3.5 V or 4.67 V depending on whether the conversion ratio at preceding A is 4:1 or 3:1. The supply voltage (VDC2) at B output from the first conversion circuit 250 may range from 3.5 V to 4.67 V.

For example, the conversion ratio may be determined based on the magnitude of the charging voltage or discharging voltage and the magnitude of the voltage required to operate the second conversion circuit 260. For example, the magnitude of the voltage required to operate the second conversion circuit 260 may be 3.3 V or more. The conversion ratio 3:1 or 4:1 determined in the example described above may be determined considering the magnitude of the charging voltage or the discharging voltage and a supply voltage, which is greater than or equal to the magnitude of the voltage required to operate the second conversion circuit 260. According to various embodiments, as described above, the conversion ratio of the first conversion circuit 250 may be determined by the processor 120 or the voltage comparator 270. In FIG. 4, the processor 120 may determine the conversion ratio by comparing the magnitude of the identified charging voltage or discharging voltage to the set voltage magnitude and supply a control signal to the first conversion circuit 250. In FIG. 4, the voltage comparator 270 may determine the conversion ratio by comparing the magnitude of the charging voltage or the discharging voltage to a set reference voltage (e.g., Ref 14 V). The voltage comparator 270 may supply the control signal to the first conversion circuit 250.

The second conversion circuit 260 according to various embodiments may convert the supply voltage and supply the converted supply voltage to a load (not shown).

The description provided above with reference to FIG. 4 is for the case of an electronic device including a 4S battery 189 where the voltage of each battery cell is greater than or equal to 3 V and less than or equal to 4.35 V. However, embodiments are not limited thereto. The battery 189 may be described with different conversion ratios even when the number of battery cells connected in series, such as in a 2S battery and a 3S battery other than the 4S battery, varies or when the voltage of each battery cell is different.

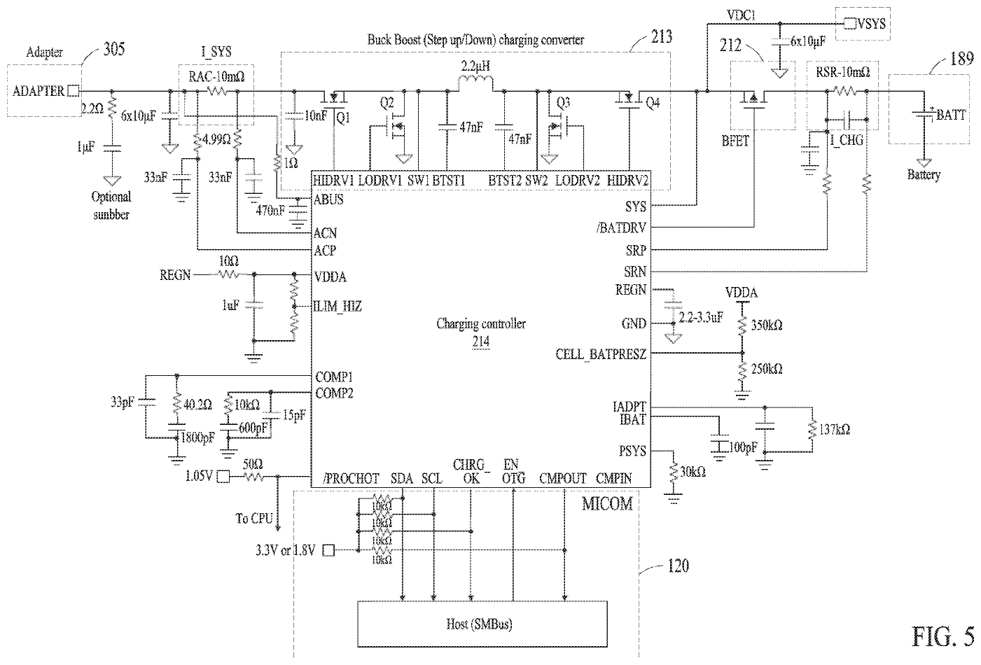

FIG. 5 is a circuit diagram of an electronic device (e.g., the electronic device 101 of FIG. 1) operating on a motherboard, according to various embodiments.

Referring to FIG. 5, the electronic device operating on the motherboard may include a buck converter 213, the semiconductor element 212, the battery 189, a charging controller 214, and the processor 120.

According to various embodiments, when the adapter 305 is inserted into the electronic device, the buck converter 213 may convert the input voltage of the input power source input from the adapter 305 to a charging voltage. The converted charging voltage (VDC1) may be supplied to the battery 189 through the semiconductor element 212. In addition, the charging voltage may be supplied to a first conversion circuit (e.g., the first conversion circuit 250 of

FIG. 2). In FIG. 5, VSYS may be connected to the first conversion circuit.

When the adapter 305 is removed, the voltage charged in the battery 189 is discharged, and thus, a discharging voltage may be supplied to the VSYS connected to the first conversion circuit (e.g., the first conversion circuit 250 of FIG. 2) through the semiconductor element 212.

In FIG. 5, the charging controller 214 may identify I_CHG, the magnitude of the current input to or output from the battery 189 and/or I_SYS, the magnitude of the current input from the adapter 305 and control the operation of the buck converter 213 and the semiconductor element 212. For example, the charging controller 214 may identify I_CHG and/or I_SYS to transmit information about a charging state to a connected processor (e.g., the processor 120 of FIG. 1) via an SMBus and control the operation of a charging circuit according to a control signal of the processor.

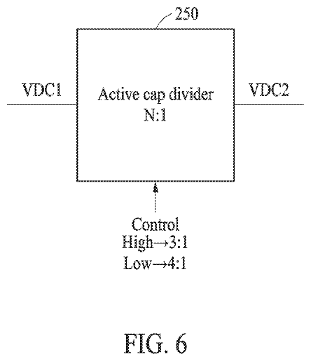

FIG. 6 is a diagram illustrating an operation of the first conversion circuit 250, according to various embodiments.

Referring to FIG. 6, the first conversion circuit 250 according to various embodiments may convert an input charging voltage (VDC1) into a supply voltage (VDC2) according to a conversion ratio (N:1).

For example, the conversion ratio of the first conversion circuit 250 may be determined based on a control signal. FIG. 6 illustrates a conversion ratio that is determined to be 3:1 when a control signal input to the first conversion circuit 250 according to an embodiment is high and 4:1 when the control signal is low.

For example, as described above, the control signal input to the first conversion circuit 250 may be determined by comparing the magnitude of the charging voltage input to the first conversion circuit 250 to a set voltage magnitude.

For example, the first conversion circuit 250 may include a capacitor divider including a plurality of capacitors and a plurality of switches. The conversion ratio of the first conversion circuit 250 may be determined based on a control signal and may thus be referred to as an active capacitor divider.

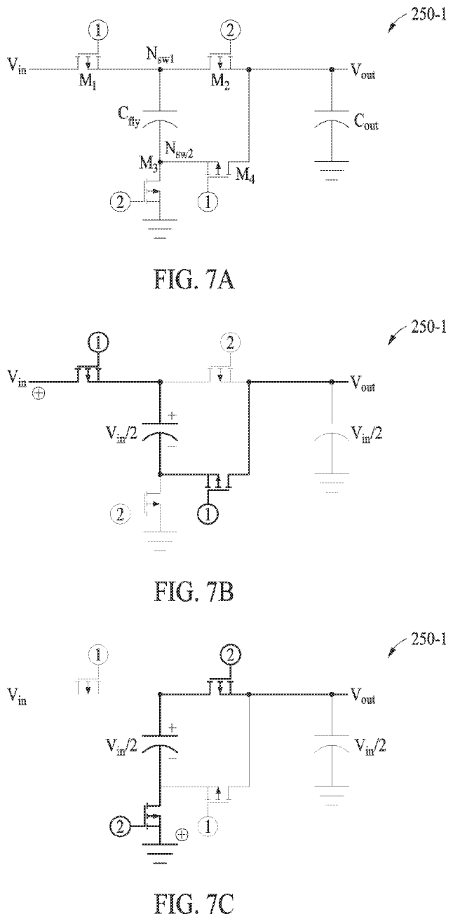

FIGS. 7A, 7B, and 7C are circuit diagrams of a first conversion circuit 250-1 having a conversion ratio of 2:1, according to various embodiments.

The first conversion circuit 250 according to various embodiments may include a plurality of switches and a plurality of capacitors. For example, the first conversion circuit 250 may charge each of the plurality of capacitors with a supply voltage according to the operation of the plurality of switches and output the supply voltage charged in the plurality of capacitors. According to an embodiment, the conversion ratio of the first conversion circuit 250 may be a ratio between the supply voltage charged in each of the plurality of capacitors of the first conversion circuit 250 and the magnitude of the charging voltage or the discharging voltage input to the first conversion circuit 250.

The plurality of switches of the first conversion circuit 250 according to various embodiments may operate according to a control signal of a processor.

FIG. 7A illustrates the first conversion circuit 250-1 with a conversion ratio of 2:1. FIGS. 7B and 7C illustrate an operation of charging capacitors Cfly and Cout with a voltage that is half the voltage magnitude of charging voltage Vin, in accordance with a conversion ratio of 2:1.

Referring to FIGS. 7A, 7B, and 7C, the first conversion circuit 250-1 with a conversion ratio of 2:1 may convert an input charging voltage (Vin) into a supply voltage (Vout) according to the 2:1 conversion ratio.

In FIG. 7B, switches M1 and M2 may be turned on to charge each of the capacitors

Cfly and Cout with a voltage of Vin/2. In FIG. 7C, switches M2 and M3 may be turned on to apply the supply voltage Vout, which is half the magnitude of the charging voltage Vin, or Vin/2. The ratio of Vin to Vout may be the conversion ratio of 2:1.

For example, the voltage output from the output terminal Vout of the first conversion circuit 250-1 may be understood as the supply voltage charged in the capacitor Cfly, the supply voltage charged in the capacitor Cout, or the supply voltage of the capacitors Cfly and Cout connected in parallel.

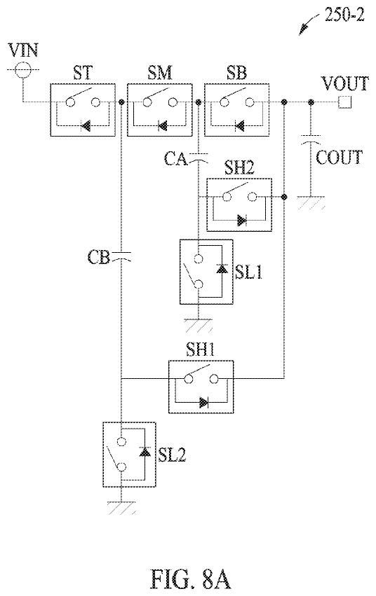

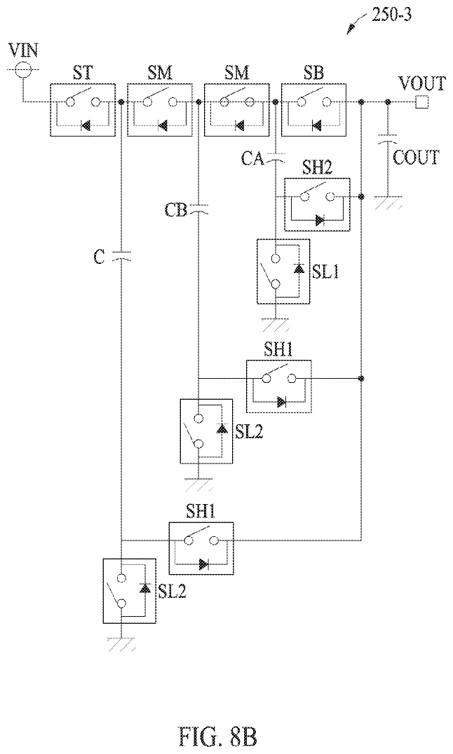

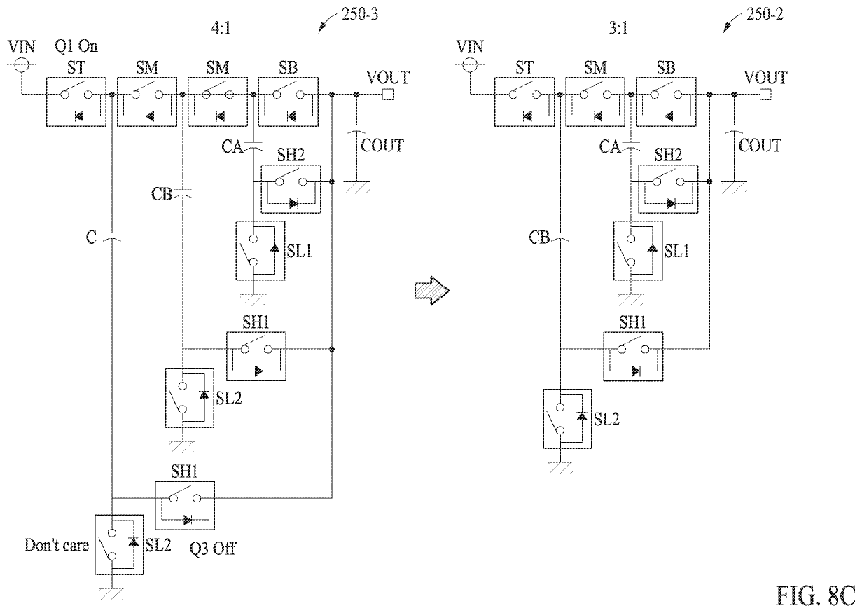

FIGS. 8A, 8B, and 8C are circuit diagrams of a first conversion circuit 250-2 having a conversion ratio of 3:1 and a first conversion circuit 250-3 having a conversion ratio of 4:1, according to various embodiments.

FIG. 8A is a diagram illustrating the first conversion circuit 250-2 with a conversion ratio of 3:1. Similar to the description provided with reference to FIGS. 7A, 7B, and 7C, depending on the operation of a switch, capacitors CB, CA, and Cout may each be charged with a supply voltage, that is, the voltage obtained by converting the charging voltage VIN according to the 3:1 conversion ratio. The supply voltage charged in each of the capacitors CB, CA, and Cout, that is, a voltage with a magnitude of VIN/3, may be applied to a VOUT terminal output from the first conversion circuit 250-2.

FIG. 8B is a diagram illustrating the first conversion circuit 250-3 with a conversion ratio of 4:1. Similar to the description provided with reference to FIGS. 7A, 7B, and 7C, depending on the operation of a switch, capacitors C, CB, CA, and Cout may each be charged with a supply voltage, that is, the voltage obtained by converting the charging voltage VIN according to the 4:1 conversion ratio. The supply voltage charged in each of the capacitors C, CB, CA, and Cout, that is, a voltage with a magnitude of VIN/4, may be applied to a VOUT terminal output from the first conversion circuit 250-3.

FIG. 8C is a diagram illustrating determination of the conversion ratio of the first conversion circuit 250 according to the operation of a plurality of switches. Referring to FIG. 8C, a processor according to various embodiments may determine the conversion ratio of the first conversion circuit 250 by controlling the operation of the plurality of switches.

The left diagram of FIG. 8C is a circuit diagram of the first conversion circuit 250-3 having a conversion ratio of 4:1. The first conversion circuit 250-3 with a conversion ratio of 4:1 may turn on switch Q1 (ST) and turn off switch Q3 (SH1) according to a control signal of the processor (e.g., the processor 120 of FIG. 1). When switches Q1 and Q3 are respectively turned on and off in the first conversion circuit 250-3 with a conversion ratio of 4:1, the first conversion circuit 250-3 may operate in the same way as the first conversion circuit 250-2 with a conversion ratio of 3:1, as illustrated in the circuit on the right side of FIG. 8C.

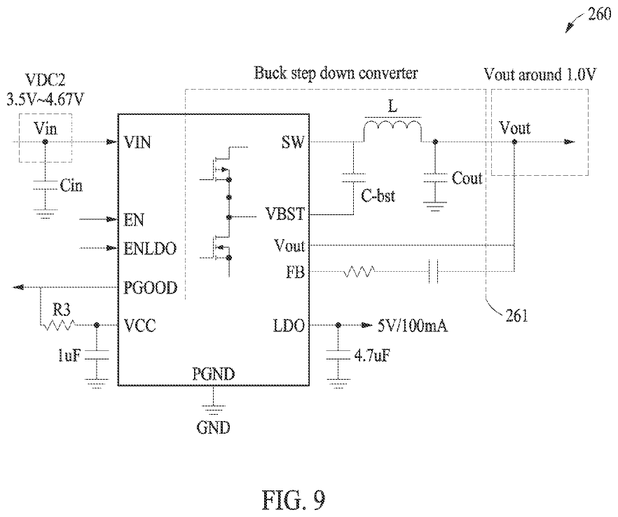

FIG. 9 is a circuit diagram of the second conversion circuit 260 according to various embodiments.

Referring to FIG. 9, the second conversion circuit 260 according to various embodiments may convert a supply voltage and supply the converted supply voltage to a load. In FIG. 9, the magnitude of the supply voltage (VDC2) input to the second conversion circuit 260 may be greater than or equal to 3.5 V and less than or equal to 4.67 V.

For example, the second conversion circuit 260 may convert the supply voltage and supply the converted supply voltage to the load using a buck step down converter 261. For example, the magnitude of the voltage (Vout) supplied to the load may be about 1.0 V. The magnitude of the voltage supplied to the load may vary depending on the load.

For example, the conversion ratio of a first conversion circuit (e.g., the first conversion circuit 250 of FIG. 2) may be determined based on the magnitude of the voltage required to operate the second conversion circuit 260 and the magnitude of the voltage input to the first conversion circuit.

For example, in the case of an electronic device (e.g., the electronic device 101 of FIG. 1) including a 4S battery, the magnitude of the voltage input to the first conversion circuit may be greater than or equal to 12 V and less than or equal to 17.4 V. The magnitude of the voltage (e.g., an IC bias voltage) required to operate the second conversion circuit 260 may be 3.3 V or more.

For example, when the magnitude of the voltage input to the first conversion circuit is greater than or equal to 12 V and less than or equal to 14 V, the processor may determine the conversion ratio of the first conversion circuit to be 3:1 such that the magnitude of the supply voltage input to a second conversion circuit is 3.5 V or more.

For example, when the magnitude of the voltage input to the first conversion circuit is greater than 14 V and less than or equal to 17.4 V, the processor may determine the conversion ratio of the first conversion circuit to be 4:1.

In the above example, when a battery (e.g., the battery 189 of FIG. 1) is a 3S battery, the magnitude of the voltage input to the first conversion circuit may be greater than or equal to 9 V and less than or equal to 13.05 V. For example, when the magnitude of the voltage input to the first conversion circuit 250 is greater than or equal to 9V and less than or equal to 13.05 V, the processor may determine the conversion ratio to be 2:1 or 3:1 such that the magnitude of a supply voltage is greater than or equal to the magnitude (e.g., 3.3 V or more) of the voltage required to operate the second conversion circuit 260.

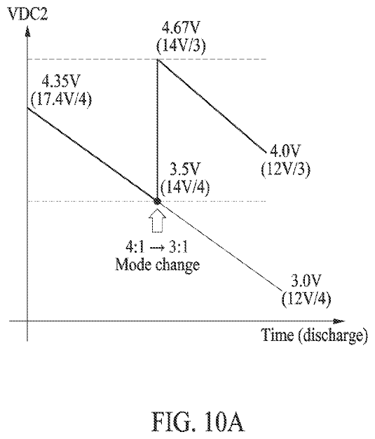

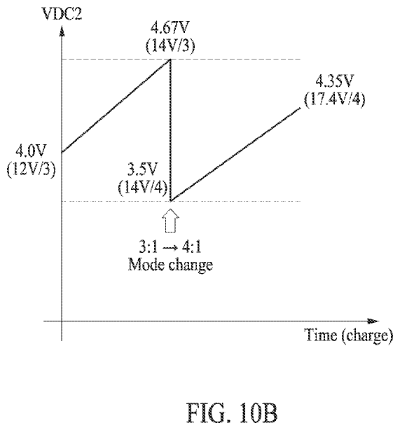

FIGS. 10A and 10B are diagrams illustrating the conversion ratio of a first conversion circuit and a supply voltage according to the magnitude of a charging voltage and a discharging voltage, according to various embodiments. FIG. 10 is a diagram illustrating the supply voltage of an electronic device (e.g., the electronic device 101 of FIG. 1) including a 4S battery with a voltage range of 12 V or more and 17.4 V or less. The range of the voltage of the battery and the serial-parallel connection structure of the battery are not limited to the example described above.

FIG. 10A is a diagram illustrating the magnitude of the supply voltage supplied to a second conversion circuit (e.g., the second conversion circuit 260 of FIG. 2) from a first conversion circuit (e.g., the first conversion circuit 250 of FIG. 1) as a battery (e.g., the battery 189 of FIG. 1) discharges, according to various embodiments.

As the battery discharges over time, the discharging voltage of the battery may decrease. According to various embodiments, a processor (e.g., the processor 120 of FIG. 1) may determine the conversion ratio of the first conversion circuit by comparing the magnitude of the discharging voltage of the battery to a set voltage magnitude.

For example, in FIG. 10A, when the magnitude of the discharging voltage is greater than the set voltage of 14 V, the processor may determine the conversion ratio of the first conversion ratio to be 4:1. For example, in FIG. 10A, when the magnitude of the discharging voltage is less than or equal to the set voltage of 14 V, the processor may determine the conversion ratio of the first conversion circuit to be 3:1.

Referring to FIG. 10A, the discharging voltage of a fully charged battery may be supplied to the first conversion circuit. For example, the discharging voltage of the fully charged battery may be 17.4 V, and the processor may determine the conversion ratio of the first conversion circuit to be 4:1. The magnitude of the supply voltage supplied to the second conversion circuit may be 4.35 V.

When the discharging voltage of the battery decreases to 14 V or less as the battery discharges, the processor may determine the conversion ratio of the first conversion circuit to be 3:1. In FIG. 10A, when the discharging voltage of the battery decreases to 14 V or less and the magnitude of the supply voltage is 3.5 V or less, the processor may control the conversion ratio of the first conversion circuit to be 3:1, and the magnitude of the supply voltage according to the conversion ratio of 3:1 may be 4.67 V.

After the conversion ratio of the first conversion circuit is changed to 3:1, as the battery discharges, the discharging voltage of the battery may decrease to 12 V, and the supply voltage may decrease to 4.0 V.

FIG. 10B is a diagram illustrating the magnitude of the supply voltage supplied to the second conversion circuit (e.g., the second conversion circuit 260 of FIG. 2) from the first conversion circuit (e.g., the first conversion circuit 250 of FIG. 1) as the battery (e.g., the battery 189 of FIG. 1) charges, according to various embodiments.

FIG. 10B, in contrast to FIG. 10A, illustrates the magnitude of the supply voltage as a fully discharged battery is being charged. The charging voltage supplied to the first conversion circuit may increase from 12 V to 14 V as the battery charges.

For example, when the magnitude of the charging voltage is greater than or equal to 12 V and less than 14 V, the processor may determine the conversion ratio of the first conversion circuit to be 3:1. For example, as the charging progresses and the magnitude of the charging voltage is 14 V or more, the processor may change the conversion ratio of the first conversion circuit to 4:1.

Referring to FIGS. 10A and 10B, the electronic device according to various embodiments may supply, to the second conversion circuit, a supply voltage that is greater than or equal to a predetermined voltage (e.g., 3.3 V or more) by determining the conversion ratio of the first conversion circuit.

FIGS. 11 to 15 are diagrams illustrating power efficiency as a supply voltage decreases, according to various embodiments.

FIGS. 11A and 11B are diagrams illustrating efficiency according to the magnitude of the supply voltage (Vin of FIG. 11) input to a second conversion circuit (e.g., the second conversion circuit 260 of FIG. 2).

Referring to FIG. 11A, in IDLE MODE and PWM MODEN, the efficiency when the supply voltage (Vin) is 7 V is greater than the efficiency when the supply voltage is 12 V or 24

V.

Referring to FIG. 11B, in a PWM mode and a burst mode operation, the efficiency when the supply voltage (Vin) is 3.6 V is greater than the efficiency when the supply voltage is 12 V.

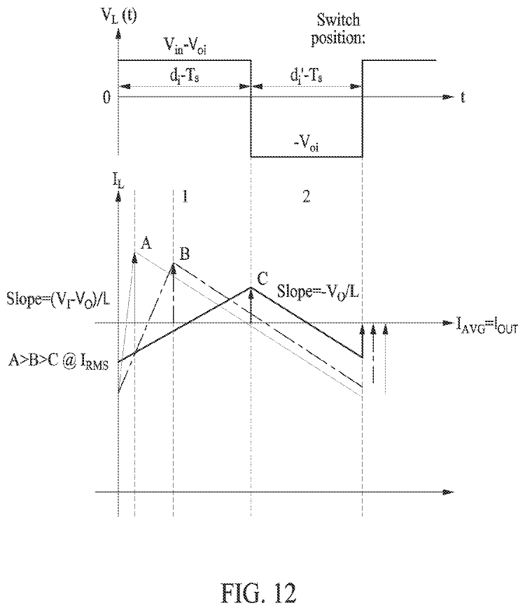

FIG. 12 is a diagram illustrating an inductor current of a buck converter, according to various embodiments. A second conversion circuit (e.g., the second conversion circuit 260 of FIG. 2) according to various embodiments may include a buck converter.

Referring to FIG. 12, the value of current I_{RMS} may be higher for the triangle wave of A with a low input-output conversion ratio compared to C with a high conversion ratio.

$${P}_{L ( Copper )} = {I}_{L ( RMS )}^{2} \cdot {R}_{DCR} \qquad ( Equation 1 )$$

In Equation 1 above, P_{L(Copper)} may denote a loss caused by an inductor coil of the buck converter, I_{L} may denote an inductor current, and R_{DCR} may denote equivalent series resistance of an inductor.

Referring to Equation 1, P_{L(Copper)} , which is a loss caused by copper of the inductor, is proportional to I²_{L(RMS)}, which is the square of an RMS value of a current, and thus, a loss of A with a low input-output voltage conversion ratio may be greater than a loss of C, as illustrated in FIG. 12.

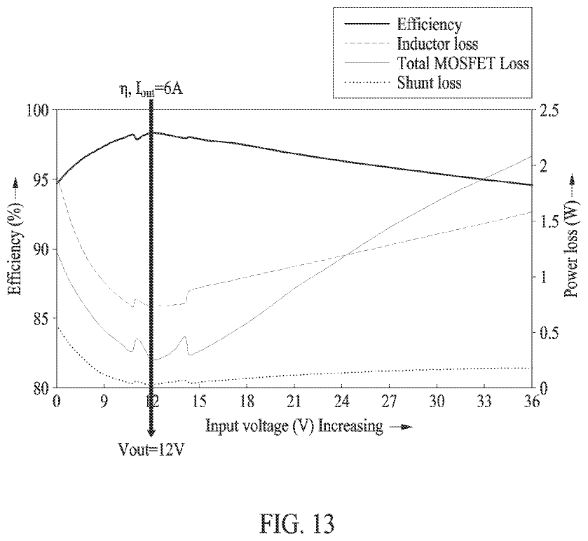

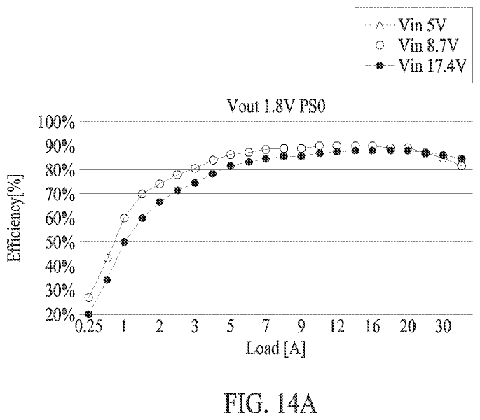

FIG. 13 is a diagram illustrating an efficiency curve according to the voltage conversion ratio of a buck converter according to various embodiments.

$${P}_{Con ( Buck )} = {I}_{OUT}^{2} [ {D}_{BUCK} {R}_{DSON Q 1} + ( 1 - {D}_{BUCK} ) {R}_{DSON Q 1} ] \\ {P}_{SW ( Buck )} = {V}_{IN} {F}_{SW} [ {I}_{OUT K} ( ( {T}_{ON Q 1} + {T}_{OFF Q 1} ) / 2 ) + {Q}_{RR Q 2} ] \qquad ( Equation 2 )$$

In Equation 2 above, P_{Con(Buck)} may denote the dissipated conduction power of a buck converter, I_{OUT} may denote the output current of the buck converter, T_{ON} may denote the on-time of a switching period, T_{OFF} may denote the off-time of the switching period, R_{DSON} may denote the on-resistance of a field effect transistor (FET), Q_{RR} may denote the amount of reverse recovery charge of the FET, V_{IN} may denote the input voltage of the buck converter, and F_{SW} may denote a switching frequency.

D_{BUCK} may denote the duty ratio of the buck converter and may be expressed by D_{BUCK}=T_{ON/}(T_{ON}+T_{OFF}). Q1 may denote an upper switch of the buck converter, and Q2 may denote a bottom switch of the buck converter. For example, R_{DSON Q1} may denote the on-resistance of the FET of the upper switch, T_{ON Q1} may denote the on-time of the switching period of the upper switch, T_{OFF Q1} may denote the off-time of the switching period of the upper switch, and Q_{RR Q2} may denote the amount of reverse recovery charge of the FET of the bottom switch.

FIG. 13 illustrates efficiency according to the conduction loss P_{Con(Buck)} and switching loss P_{SW(Buck)} of a switch (e.g., a metal-oxide-semiconductor field effect transistor (MOSFET)) of the buck converter.

Referring to FIG. 13, efficiency is high when Vout, which is the output voltage of the buck converter, is 12 V and V, which is the input voltage of the buck converter, is around 12 V, that is, when an input-output voltage conversion ratio is close to 1. The efficiency gradually decreases as the input-output voltage conversion ratio decreases while the V, the input voltage, increases.

For example, a second conversion circuit may convert a supply voltage and supply the converted supply voltage to a load, and the magnitude of the voltage supplied to the load may be less than the magnitude of the supply voltage. Referring to FIG. 13, the second conversion circuit may operate in a region in which a conversion ratio is less than 1. Referring to FIG. 13, according to various embodiments, the total MOSFET loss of the second conversion circuit decreases as the conversion ratio becomes less than 1, and the efficiency of the second conversion circuit increases as the conversion ratio becomes less than 1.

For example, the magnitude of the total MOSFET loss generated in a first conversion circuit may be less than the magnitude of the MOSFET loss of the second conversion circuit that decreases as a supply voltage is supplied from the first conversion circuit to the second conversion circuit.

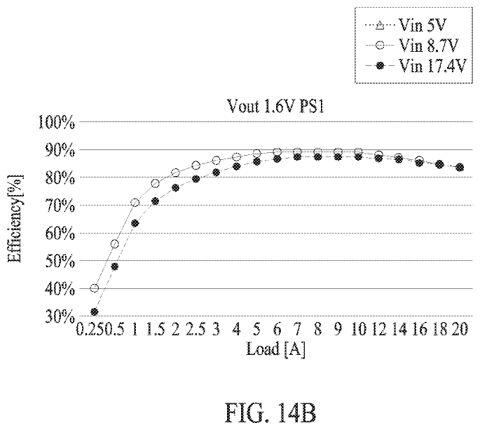

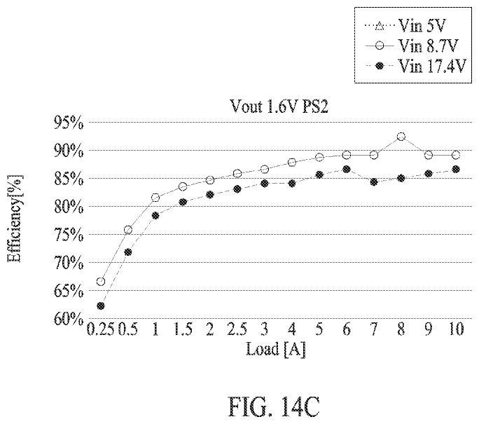

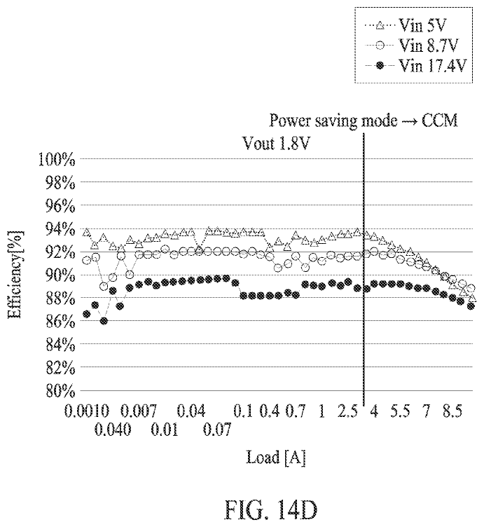

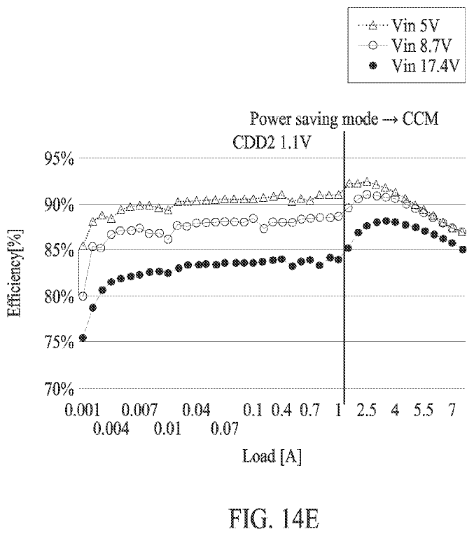

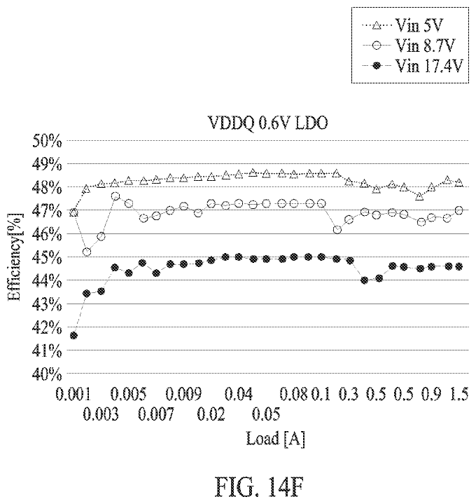

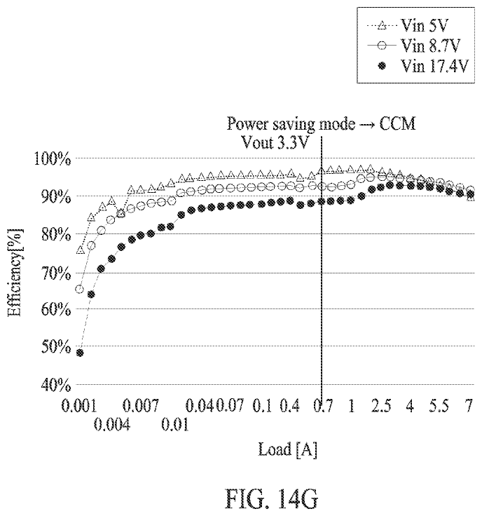

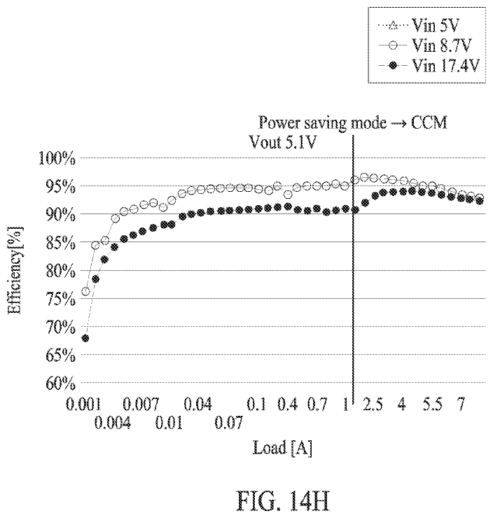

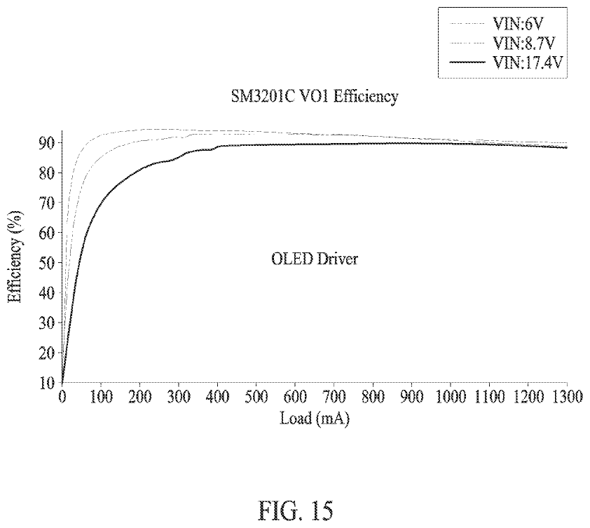

FIGS. 14 and 15 are diagrams illustrating efficiency measured according to the magnitude (Vin) of the input voltage input to each second conversion circuit (e.g., the second conversion circuit 260 of FIG. 2).

Referring to FIGS. 14A to 14H, when the magnitude of the supply voltage (Vin) input to the second conversion circuit is small, the efficiency of the second conversion circuit that supplies various magnitudes of voltage to a load may be high.

Referring to FIG. 15, when the magnitude of the supply voltage (VIN) input to an organic light-emitting diode (OLED) driver is small, efficiency may be high.

Referring to FIGS. 11 to 15, as the input-output voltage conversion ratio of the second conversion circuit of an electronic device according to various embodiments increases, power efficiency may increase.

The electronic device according to various embodiments may supply, to the second conversion circuit, a supply voltage, which is converted from a charging voltage or a discharging voltage in the first conversion circuit according to a conversion ratio. The electronic device according to various embodiments may increase the input-output voltage conversion ratio of the second conversion circuit by providing the supply voltage to the second conversion circuit.

For example, the input-output voltage conversion ratio when the charging voltage or the discharging voltage is not converted according to the conversion ratio of the first conversion circuit and is applied as an input to the second conversion circuit may be less than the input-output voltage conversion ratio when the supply voltage converted in the first conversion circuit is applied as an input to the second conversion circuit.

According to various embodiments, the first conversion circuit of the electronic device may consume power. The magnitude of the power consumed by the first conversion circuit may be less than the magnitude of the power that increases as the input-output voltage conversion ratio of the second conversion circuit increases.

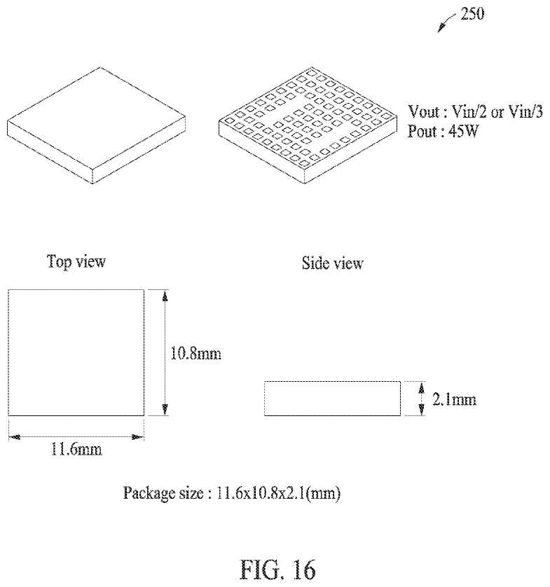

FIG. 16 is a diagram illustrating a first conversion circuit operating on a motherboard, according to various embodiments.

Referring to FIG. 16, a first conversion circuit according to various embodiments may include a plurality of capacitors and a plurality of switches. The first conversion circuit illustrated in FIG. 16 is obtained by integrating the plurality of capacitors and the plurality of switches.

Referring to FIGS. 5 and 16, a battery, a charging circuit, a first conversion circuit, a second conversion circuit, and a processor of an electronic device according to various embodiments may be disposed on a motherboard and connected to one another and may transmit power to each load.

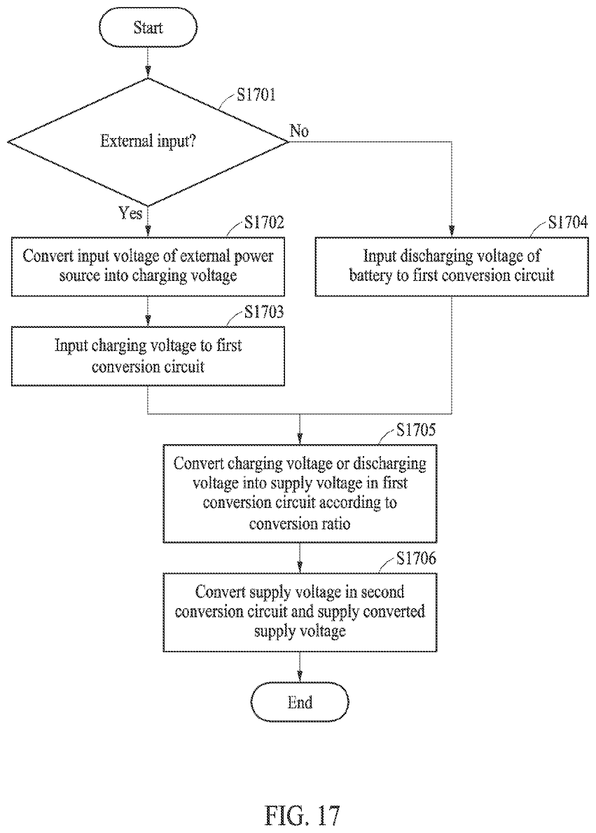

FIG. 17 is a flowchart of an operation of a power transfer method according to various embodiments.

Referring to FIG. 17, in operation S1701, an electronic device (e.g., the electronic device 101 of FIG. 1) according to various embodiments may identify whether an external power source is input. For example, when the external power source is input through an adapter (e.g., the adapter 305 of FIG. 3), a signal such as ADT_SEL (active high) may be transmitted from a charging circuit (e.g., the charging circuit 210 of FIG. 2) to a processor (e.g., the processor 120 of FIG. 1).

In operation S1702, when the external power source is input, the electronic device according to various embodiments may convert the input voltage of the external power source to a charging voltage using the charging circuit (e.g., the charging circuit 210 of FIG. 2). For example, the charging voltage output from the charging circuit may depend on the voltage of a battery (e.g., the battery 189 of FIG. 1).

In operation S1703, when the external power source is input, the electronic device according to various embodiments may input the charging voltage to a first conversion circuit (e.g., the first conversion circuit 250 of FIG. 2). For example, the charging voltage may be applied to both the battery and the first conversion circuit simultaneously. The charging voltage applied to the battery may charge the battery.

In operation S1704, when the external power source is not input, the electronic device according to various embodiments may input the discharging voltage of the battery to the first conversion circuit. The discharging voltage of the battery may be understood as being the same as the voltage charged in the battery.

In operation S1705, the electronic device according to various embodiments may convert the charging voltage or the discharging voltage into a supply voltage in the first conversion circuit according to a conversion ratio. For example, the conversion ratio of first conversion circuit may be N:1. The conversion ratio N:1 of the first conversion circuit may be determined based on the magnitude of the charging voltage or the discharging voltage supplied to the first conversion circuit and the magnitude of the voltage required to operate the second conversion circuit (e.g., the second conversion circuit 260 of FIG. 2). For example, when the charging voltage or the discharging voltage is greater than or equal to 14 V and less than or equal to 17.4 V and the magnitude of the voltage for operating the second conversion circuit is 3.3 V or more, the conversion ratio may be determined to be 3:1 or 4:1.

The electronic device according to the various embodiments may determine the conversion ratio of the first conversion circuit. For example, the electronic device may determine the conversion ratio of the first conversion circuit according to the magnitude of the charging voltage or the discharging voltage input to the first conversion circuit and a set voltage magnitude. For example, the electronic device may determine a conversion ratio of 4:1 when the magnitude of the charging voltage or the discharging voltage input to the first conversion circuit is 14 V or more and a conversion ratio of 3:1 when the magnitude of the charging voltage or the discharging voltage is less than 14 V.

In operation S1706, the electronic device according to various embodiments may convert the supply voltage in the second conversion circuit and supply the converted supply voltage to a load. As the supply voltage converted according to the conversion ratio in the first conversion circuit is supplied to the second conversion circuit, the input-output voltage conversion ratio of the second conversion circuit may increase. When the input-output voltage conversion ratio is high, the power efficiency of the second conversion circuit may be high.

According to various embodiments, an electronic device (e.g., the electronic device 101 of FIG. 1) for executing a power transfer method may include a battery (e.g., the battery 189 of FIG. 1), a charging circuit (e.g., the charging circuit 210 of FIG. 2) configured to, when an external power source is input, convert an input voltage of the external power source into a charging voltage for charging the battery 189, a first conversion circuit (e.g., the first conversion circuit 250 of FIG. 2) configured to convert one of a discharging voltage and the charging voltage of the battery 189 into a supply voltage according to a conversion ratio, a second conversion circuit (e.g., the second conversion circuit 260 of FIG. 2) configured to convert the supply voltage and supply the converted supply voltage to a load, and a processor (e.g., the processor 120 of FIG. 1) configured to control the charging circuit 210 and the first conversion circuit 250, wherein the processor 120 may be configured to enable the charging voltage to be input to the first conversion circuit 250 when the external power source is input and enable the discharging voltage to be input to the first conversion circuit 250 when the external power source is not input.

The processor 120 may be configured to identify a magnitude of the discharging voltage or the charging voltage and determine the conversion ratio by comparing the discharging voltage or the charging voltage to a set voltage magnitude.

The processor 120 may be configured to determine that the conversion ratio when the magnitude of the discharging voltage or the charging voltage is greater than or equal to the set voltage magnitude is less than the conversion ratio when the magnitude of the discharging voltage or the charging voltage is less than the set voltage magnitude.

The first conversion circuit 250 may include a plurality of switches and a plurality of capacitors, and the processor 120 may be configured to charge each of the plurality of capacitors with the supply voltage and control operation of the plurality of switches to output the supply voltage charged in the plurality of capacitors.

The processor 120 may be configured to determine the conversion ratio by controlling the operation of the plurality of switches.

According to various embodiments, an electronic device 101 for executing a power transfer method may include a battery 189, a charging circuit 210 configured to provide a charging voltage using an input external power source, a first conversion circuit 250 configured to convert a voltage transmitted from the battery 189 or the charging circuit 210 into a supply voltage according to a conversion ratio, a second conversion circuit 260 configured to convert the supply voltage into a voltage required for a connected load, and a processor 120 configured to control operation of the charging circuit 210 and the first conversion circuit 250, wherein the processor 120 may be configured to charge the battery 189 using the charging voltage and enable the charging voltage to be input to the first conversion circuit 250 when the external power source is input and enable a discharging voltage output from the battery to be input to the first conversion circuit 250 when the external power source is not input, and the conversion ratio may be determined based on a magnitude of the charging voltage or the discharging voltage and a magnitude of a voltage required to operate the second conversion circuit 260.

The processor 120 may be configured to identify a magnitude of the discharging voltage or the charging voltage and determine the conversion ratio by comparing the discharging voltage or the charging voltage to a set voltage magnitude.

The first conversion circuit 250 may include a plurality of switches and a plurality of capacitors, and the processor 120 may be configured to charge each of the plurality of capacitors with the supply voltage and control operation of the plurality of switches to output the supply voltage charged in the plurality of capacitors.

According to various embodiments, an electronic device 101 for executing a power transfer method may include a battery 189, a charging circuit 210 configured to provide a charging voltage using an input external power source, an first conversion circuit 250 configured to convert a voltage transmitted from the battery or the charging circuit into a supply voltage, a second conversion circuit 260, such as DC-to-DC converter, configured to convert the supply voltage into a voltage required for a connected load, and a processor 120 configured to control operation of the charging circuit and the active capacitor divider, wherein the processor may be configured to charge the battery using the charging voltage and enable the charging voltage to be input to the active capacitor divider when the external power source is input, enable a discharging voltage output from the battery to be input to the active capacitor divider when the external power source is not input, and control the active capacitor divider according to a magnitude of the charging voltage or the discharging voltage.

The processor 120 may be configured to identify the magnitude of the discharging voltage or the charging voltage and determine a conversion ratio of the active capacitor divider by comparing the magnitude of the discharging voltage or the charging voltage to a set voltage magnitude.

The first conversion circuit 250, which may be an active cap divider, may include a plurality of switches and a plurality of capacitors, and the processor may charge each of the plurality of capacitors with the supply voltage and control operation of the plurality of switches to output the supply voltage charged in the plurality of capacitors.

According to various embodiments, a power transfer method may include, when an external power source is input, converting an input voltage of the external power source into a charging voltage for charging a battery 189, converting a charging one of a discharging voltage or the charging voltage of the battery 189 input to a first conversion circuit 250 into a supply voltage, and converting the supply voltage in a second conversion circuit 260 and supplying the converted supply voltage to a load, wherein the converting of one of the discharging voltage or the charging voltage of the battery into the supply voltage may include enabling the charging voltage to be input to the conversion circuit when the external power source is input and enabling the discharging voltage to be input to the conversion circuit when the external power source is not input.

The power transfer method may further include identifying a magnitude of the discharging voltage or the charging voltage, and the converting of one of the discharging voltage or the charging voltage into the supply voltage may include determining the conversion ratio by comparing the magnitude of the discharging voltage or the charging voltage to a set voltage magnitude.

The converting of one of the discharging voltage or the charging voltage into the supply voltage may include determining that the conversion ratio when the magnitude of the discharging voltage or the charging voltage is greater than or equal to the set voltage magnitude is less than the conversion ratio when the magnitude of the discharging voltage or the charging voltage is less than the set voltage magnitude.

The first conversion circuit 250 may include a plurality of switches and a plurality of capacitors, and the converting of the supply voltage may include charging each of the plurality of capacitors with the supply voltage by controlling the plurality of switches and outputting the supply voltage charged in the plurality of capacitors by controlling the plurality of switches.

The converting of the supply voltage may include determining the conversion ratio by controlling operation of the plurality of switches.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the present disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “Ist” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with various embodiments of the present disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101) For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the present disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device for executing a power transfer method, the electronic device comprising:
a battery;
a charging circuit configured to, when an external power source is input, convert an input voltage of the external power source into a charging voltage for charging the battery;
a first conversion circuit configured to convert one of a discharging voltage and the charging voltage of the battery into a supply voltage according to a conversion ratio;
a second conversion circuit configured to convert the supply voltage and supply the converted supply voltage to a load; and
a processor configured to control the charging circuit and the first conversion circuit,
wherein the processor is configured to enable the charging voltage to be input to the first conversion circuit when the external power source is input and enable the discharging voltage to be input to the first conversion circuit when the external power source is not input.

2. The electronic device of claim 1, wherein the processor is configured to identify a magnitude of the discharging voltage or the charging voltage and determine the conversion ratio by comparing the magnitude of the discharging voltage or the charging voltage to a set voltage magnitude.

3. The electronic device of claim 2, wherein the processor is configured to determine that the conversion ratio when the magnitude of the discharging voltage or the charging voltage is greater than or equal to the set voltage magnitude is less than the conversion ratio when the magnitude of the discharging voltage or the charging voltage is less than the set voltage magnitude.

4. The electronic device of claim 1, wherein
the first conversion circuit comprises a plurality of switches and a plurality of capacitors, and
the processor is configured to charge each of the plurality of capacitors with the supply voltage and control operation of the plurality of switches to output the supply voltage charged in the plurality of capacitors.

5. The electronic device of claim 4, wherein the processor is configured to determine the conversion ratio by controlling operation of the plurality of switches.

6. A power transfer method comprising:
based on a determination that an external power source is input, converting an input voltage of the external power source into a charging voltage for charging a battery;
converting one of a discharging voltage or the charging voltage of the battery input to a first conversion circuit into a supply voltage according to a conversion ratio; and
converting the supply voltage in a second conversion circuit and supplying the converted supply voltage to a load,
wherein the converting of one of the discharging voltage or the charging voltage of the battery into the supply voltage comprises enabling the charging voltage to be input to the first conversion circuit when the external power source is input and enabling the discharging voltage to be input to the first conversion circuit when the external power source is not input.

7. The power transfer method of claim 6, further comprising:
identifying a magnitude of the discharging voltage or the charging voltage,
wherein the converting of one of the discharging voltage or the charging voltage of the battery into the supply voltage comprises determining the conversion ratio by comparing the magnitude of the discharging voltage or the charging voltage to a set voltage magnitude.

8. The power transfer method of claim 7, wherein the converting of one of the discharging voltage or the charging voltage of the battery into the supply voltage comprises determining that the conversion ratio when the magnitude of the discharging voltage or the charging voltage is greater than or equal to the set voltage magnitude is less than the conversion ratio when the magnitude of the discharging voltage or the charging voltage is less than the set voltage magnitude.

9. The power transfer method of claim 6, wherein the first conversion circuit comprises a plurality of switches and a plurality of capacitors, and the converting of the supply voltage comprises:
charging each of the plurality of capacitors with the supply voltage by controlling the plurality of switches; and
outputting the supply voltage charged in the plurality of capacitors by controlling the plurality of switches.

10. The power transfer method of claim 9, wherein the converting of the supply voltage comprises determining the conversion ratio by controlling operation of the plurality of switches.

11. An electronic device for executing a power transfer method, the electronic device comprising:
a battery;
a charging circuit configured to receive an input voltage from an external power source and to convert the input voltage into a charging voltage for charging the battery;
a first conversion circuit configured to convert a discharging voltage and the charging voltage of the battery into a supply voltage;
a second conversion circuit configured to convert the supply voltage into a load voltage and supply the load voltage to a load; and
a processor configured to control the charging circuit and the first conversion circuit, wherein the processor is configured to enable the charging voltage to be input to the first conversion circuit when the external power source is connected to the electronic device and to enable the discharging voltage to be input to the first conversion circuit when the external power source is not connected to the electronic device, and
wherein the first conversion circuit is configured to selectively operate at one of two or more conversion ratios.

12. The electronic device of claim 11, wherein the processor is configured to identify a magnitude of the discharging voltage or the charging voltage and determine the conversion ratio by comparing the magnitude of the discharging voltage or the charging voltage to a set voltage magnitude.

13. The electronic device of claim 12, wherein the processor is configured to determine that the conversion ratio when the magnitude of the discharging voltage or the charging voltage is greater than or equal to the set voltage magnitude is less than the conversion ratio when the magnitude of the discharging voltage or the charging voltage is less than the set voltage magnitude.
